(19) United States
(12) Patent Application Publication
(10) Pub. No.: US 2015/0116763 A1
(43) Pub. Date: Apr. 30, 2015

(54) METHOD OF EXECUTING WEB APPLICATION IN IMAGE FORMING APPARATUS AND IMAGE FORMING APPARATUS TO PERFORM THE METHOD

(71) Applicant: Samsung Electronics Co., Ltd., Suwon-si (KR)

(72) Inventor: Ju-ho EUM, Anyang-si (KR)

(73) Assignee: Samsung Electronics Co., Ltd., Suwon-si (KR)

(21) Appl. No.: 14/503,808

(22) Filed: Oct. 1, 2014

(30) Foreign Application Priority Data
Oct. 30, 2013 (KR) 10-2013-0130455

(51) Int. Cl. G06F 17/30; G06F 3/12

(52) U.S. Cl. CPC G06F 17/30893; G06F 3/1293
USPC 358/1.15; 715/234

(57) ABSTRACT

A method of executing a web application in an image forming apparatus includes receiving an input to execute a web application in the image forming apparatus, reading a hypertext markup language (HTML) file by connecting to a server supporting the web application, generating text data by analyzing the HTML file, and displaying the text data on a display unit provided in the image forming apparatus.

### CROSS-REFERENCE TO RELATED APPLICATIONS

This application claims priority under 35 U.S.C. §119(a) Korean Patent Application No. 10-2013-0130455, filed on Oct. 30, 2013, in the Korean Intellectual Property Office, the disclosure of which in its entirety is incorporated herein by reference.

### BACKGROUND OF THE INVENTION

1. Field of the Invention

The present general inventive concept relates to a method of executing a web application in an image forming apparatus.

2. Description of the Related Art

Conventional, service solutions provided through web applications have been used widely in an image forming apparatus such as a printer, a scanner, or a multi-functional machine.

In order to execute a web-application based on hypertext mark-up language (HTML) in an image forming apparatus, a browser capable of displaying an HTML page transmitted from a web application server is necessary.

However, image forming apparatuses including two-line liquid crystal displays (LCDs) or four-line LCDs capable of displaying data of text format only without supporting a browser are commonly used, and thus, a method of using a web-service solution based on HTML in such apparatuses is necessary.

### SUMMARY OF THE INVENTION

The present general inventive concept provides a method of executing a web-application based on hypertext mark-up language (HTML) in an image forming apparatus including a liquid crystal display (LCD) panel capable of displaying only text images.

Additional features and utilities of the present general inventive concept will be set forth in part in the description which follows and, in part, will be obvious from the description, or may be learned by practice of the general inventive concept.

The foregoing and/or other features and utilities of the present general inventive concept are achieved by providing a method of executing a web application, the method including, receiving an input to execute a web application in an image forming apparatus, reading a hypertext markup language (HTML) file by connecting to a server supporting the web application, generating text data by analyzing the HTML file, and displaying the text data on a display unit provided in the image forming apparatus.

The generating of the text data may include generating the text data so as to only include character string included in the HTML file, except corresponding to graphic configurations in the HTML file.

The method may further include receiving an input of selecting one of the at least one character string included in the text data displayed on the display unit, and performing an image forming job corresponding to the selected character string according to the web application.

The display unit may be a liquid crystal display (LCD) panel capable of displaying a plurality of character string lines, and the text data defines a character string to be displayed on each of the plurality of character string lines in the LCD panel.

The generating of the text data may include extracting some of tags included in the HTML file, and generating the text data according to the tags that are extracted.

The generating of the text data may include extracting at least one of a form tag, an a tag, a select tag, and an option tag included in the HTML file, and analyzing the tag that is extracted to generate the text data.

If a tag to input text is extracted from the HTML file, the text data may include a space to receive text input.

If a tag corresponding to a link is extracted from the HTML file, the text data may include at least one character string included in the tag that is extracted, and when one of the at least one character string is selected, a destination defined by the tag that is extracted is connected.

If a tag to select an option is extracted from the HTML file, the text data may include at least one character string included in the tag that is extracted, and when one of the at least one character string is selected, an option defined by the tag that is extracted is set.

The foregoing and/or other features and utilities of the present general inventive concept may also be achieved by providing a non-transitory computer-readable recording medium having embodied thereon a computer program to execute a method of executing a web application, wherein the method includes receiving an input to execute a web application in an image forming apparatus, reading a hypertext markup language (HTML) file by connecting to a server supporting the web application, generating text data by analyzing the HTML file, and displaying the text data on a display unit provided in the image forming apparatus.

The foregoing and/or other features and utilities of the present general inventive concept may also be achieved by providing an image forming apparatus to execute a web application, the image forming apparatus including a display unit to display character strings, a web service server to read a hypertext markup language (HTML) file from a web application installed in a server, a text viewer to generate text data by analyzing the HTML file, a control unit to display the text data on the display unit, and to control execution of the web application, and an image forming job execution unit to perform an image forming job according to the execution of the web application.

The text viewer may generate the text data so that the text data may only include character string included in the HTML file except corresponding to graphic configurations included in the HTML file.

The control unit may receive an input of selecting one of at least one character string included in the text data displayed on the display unit, the control unit may control the image forming job execution unit to perform an image forming job corresponding to the character string that is selected according to the web application.

The display unit may be a liquid crystal display (LCD) panel capable of displaying a plurality of character string lines, and the text viewer generates the text data so as to define a character string to be displayed in each of the plurality of character string lines of the LCD panel.

The text viewer may extract some of tags included in the HTML file, and generates the text data according to the tags that are extracted.

The text viewer may extract at least one of a form tag, an a tag, a select tag, and an option tag included in the HTML file, and analyzes the tag that is extracted to generate the text data.

If a tag to input text is extracted from the HTML file, the text viewer may generate the text data so as to include a space for receiving text input.

If a tag corresponding to a link is extracted from the HTML file, the text viewer may generate the text data so as to include at least one character string included in the tag that is extracted, and when one of the at least one character string is selected, the control unit connects to a destination defined by the tag that is extracted.

If a tag to select an option is extracted from the HTML file, the text viewer may generate the text data so as to include at least one character string included in the tag that is extracted, and when one of the at least one character string is selected, the control unit sets an option defined by the tag that is extracted.

The foregoing and/or other features and utilities of the present general inventive concept may also be achieved by providing an image forming apparatus to execute a web application, the image forming apparatus comprising a display unit, a text viewer to convert an image in a web application corresponding to a function into a selectable character string displayed on the display unit, and an image forming job execution unit to perform the function upon selection of the character string.

The display unit may be a text only display unit.

The text viewer may perform the conversion by extracting tags included in an HTML file to generate text data in a format according to the extracted tags.

The extracted tags may include at least one of a form tag, an a tag, a select tag, and an option tag.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a diagram illustrating an environment implementing a method if executing a web application according to an exemplary embodiment of the present general inventive concept;

FIG. 2 is a block diagram of an image forming apparatus and a web-application server, according to an exemplary embodiment of the present general inventive concept;

FIG. 3 is a block diagram of a web service server of FIG. 2;

FIG. 4 is a diagram of a text viewer illustrated in FIG. 2;

FIG. 5 is a diagram of a display unit and a manipulation panel provided in an image forming apparatus according to an exemplary embodiment of the present general inventive concept;

FIG. 6 is a diagram illustrating processes of inputting a command to execute a web application according to an exemplary embodiment of the present general inventive concept;

FIG. 7 is a diagram illustrating processes of displaying text data generated by interpreting an HTML file according to an exemplary embodiment of the present general inventive concept;

FIGS. 8 through 10 are diagrams illustrating processes of displaying text data by interpreting a tag of an HTML file according to exemplary embodiments of the present general inventive concept;

FIG. 11 is a diagram illustrating processes of setting an option through a text data screen, according to an exemplary embodiment of the present general inventive concept;

FIG. 12 is a diagram illustrating operations performed by a multi-functional machine and an application server when a web application is executed according to an exemplary embodiment of the present general inventive concept; and

FIGS. 13 through 17 are flowcharts illustrating methods of executing a web application according to exemplary embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

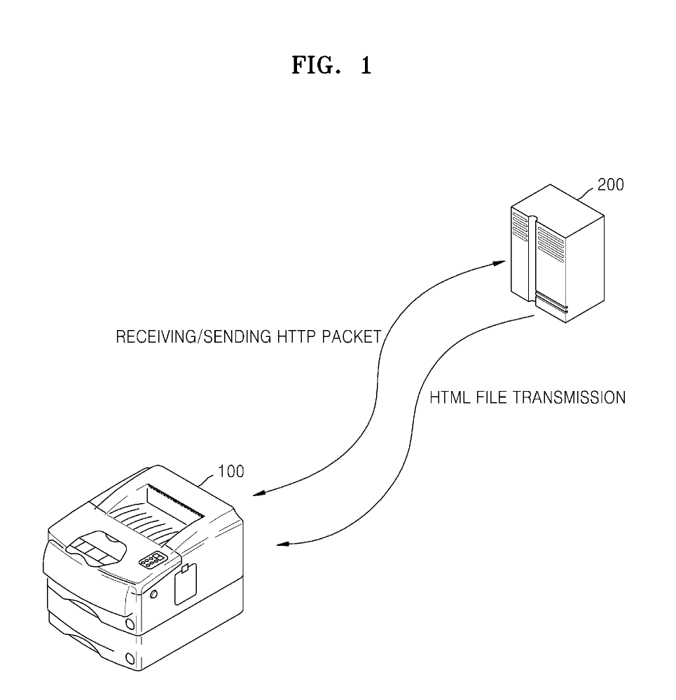

FIG. 1 is a diagram of an environment implementing a method of executing a web application according to an exemplary embodiment of the present general inventive concept. As illustrated in FIG. 1, a web application is executed by communication between an image forming apparatus 100 and a web application server 200. The web application is actually provided and executed in the web application server 200, and performs a solution using functions of the image forming apparatus 100. To do this, hypertext transfer protocol (HTTP) packets are transferred between the image forming apparatus 100 and the web application server 200. The image forming apparatus 100 stores a uniform resource locator (URL) address of the web application server 200, and when a command to execute the web application is input, the image forming apparatus 100 accesses the web application server 200 to read a hypertext mark-up language (HTML) file about the web application and display the HTML file on a display unit.

It is assumed that the image forming apparatus 100 according to FIG. 1 includes a liquid crystal display (LCD) panel that does not support a browser, but only display data of text format. However, HTML files read from the web application server 200 generally include graphic components corresponding to a graphic user interface (GUI). Therefore, the HTML file has to be converted into text data that may be displayed appropriately on an LCD panel capable of only displaying data of text format.

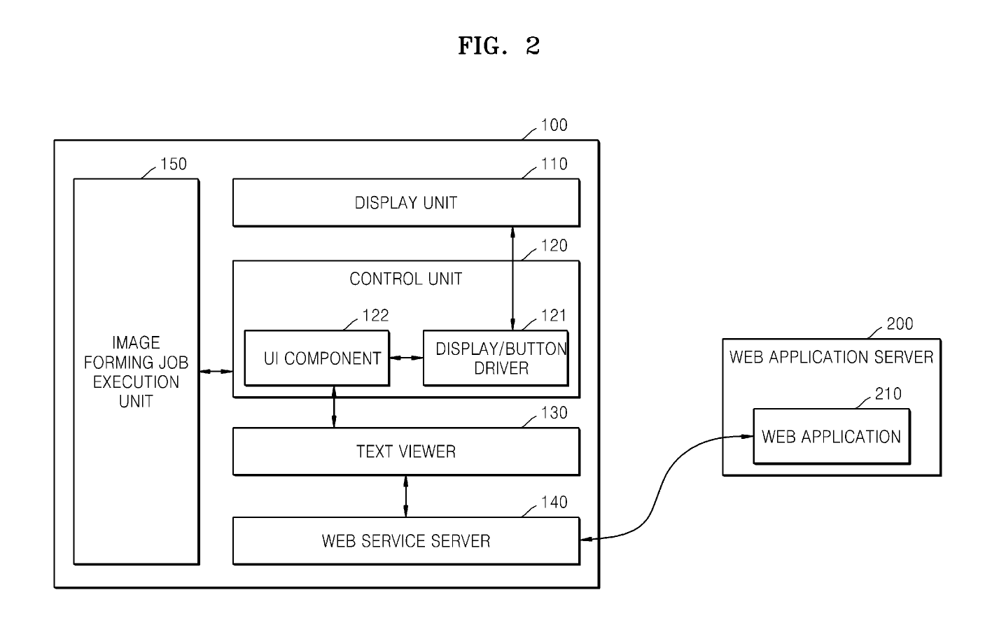

FIG. 2 is a diagram illustrating the image forming apparatus 100 and the web application server 200 in more detail, according to an exemplary embodiment of the present general inventive concept. Referring to FIG. 2, the image forming apparatus 100 includes a display unit 110, a control unit 120, a text viewer 130, a web service server 140, and an image forming job execution unit 150. Here, the control unit 120 may include a display/button driver 121, and a user interface (UI) component 122. The web application server 200 includes the web application unit 210.

The display unit 110 displays an operating status of the image forming apparatus 100 and various information, and may display an execution screen of the web application. According to FIG. 2, it is assumed that the display unit 110 is an LCD panel only capable of only displaying data of text format. For example, a two-line LCD or a four-line LCD may be used as the display unit 110.

The control unit 120 controls execution of the web application, allows the display unit 110 to display a screen according to the execution of the web application, and controls the image forming apparatus 100 to perform an image forming job according to the execution of the web application.

Meanwhile, the control unit 120 includes a display/button driver 121 and a UI component 122, and the display/button driver 121 transfers one selected from information recognized by a hard button provided in the image forming apparatus 100 and a character string displayed on the display unit 110 to the UI component 122 and displays text data generated by the text viewer 130 on the display unit 110. In addition, the UI component 122 maintains all character strings included in a screen displayed on the display unit 110 and software function to control the character strings.

The text viewer 130 analyzes the HTML file read from the web application server 200 to generate text data, and transmits the text data to the control unit 120 so that the text data may be displayed on the display unit 110 via the UI component 122 and the display/button driver 121.

The text viewer 130 generates the text data only including the character strings included in the HTML file, with an exception of graphic components included in the HTML file read from the web application server 200, because the display unit 110 according to FIG. 2 is an LCD that is only capable of displaying data of the text format and may not display graphics. Here, functions executed via the graphic components included in the HTML file may be configured to be executed through manipulation of the hard button provided in the image forming apparatus 100 and selection of the character string included in the text data.

For example, regarding a submit function in an input type of a form tag, a submit button is displayed as a graphic in a browser, and when a user inputs text and clicks the submit button, the input text is transferred to the server. However, according to FIG. 2, the submit button that is a graphic component is not displayed, and when the user inputs the text and clicks a confirm button from among the hard buttons provided in the image forming apparatus 100, the input text is transferred to the server. With respect to other tags of different types, the functions corresponding to the tags may be performed by moving and confirming through the hard buttons, without displaying the graphic components.

In addition, if the display unit 110 is an LCD panel capable of displaying a plurality of character strings such as a two-line LCD or a four-line LCD, the text viewer 130 may generate the text data so as to define a character string that will be displayed in each of the lines of the LCD panel.

The text viewer 130 extracts some of the tags included in the HTML file, and may generate text data of an appropriate format according to the extracted tags. For example, at least one of a form tag, an a tag, a select tag, and an option tag from among the tags included in the HTML file is extracted, and the extracted tag is interpreted to generate the text data according to the extracted tag.

If the HTML file includes a tag to input text such as input type=“text” of the form tag, the text viewer 130 may extract the tag and may generate the text data including a space to receive the input of the text. For example, one of the plurality of lines in the LCD panel remains empty in order to display the text input by the user.

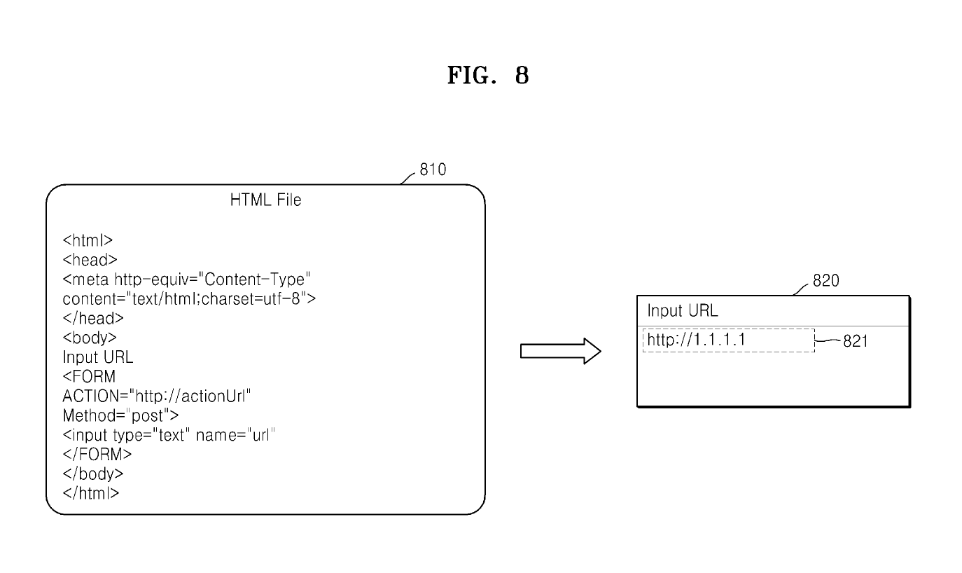

FIG. 8 illustrates a detailed example of a process of displaying text data by a tag of an HTML file. Referring to FIG. 8, an HTML file 810 includes a form tag to input text. Therefore, the text data is generated so as to include a space to receive text input, and the text data is displayed on an LCD screen 820. A region 821 in the LCD screen 820 is displayed as an empty space to receive the text input. In addition, when a user inputs a text “http://1.1.1.1”, the input text is displayed in the region 821. In addition, the LCD screen 820 displays a text string “Input URL” included in the HTML file 810.

If the HTML file 810 includes a tag corresponding to a link such as the a tag, the text viewer 130 extracts the a tag and generates text data including the character strings included in the a tag. In addition, if one of the character strings displayed on the display unit 110 is selected, a destination defined by the extracted tag may be accessed.

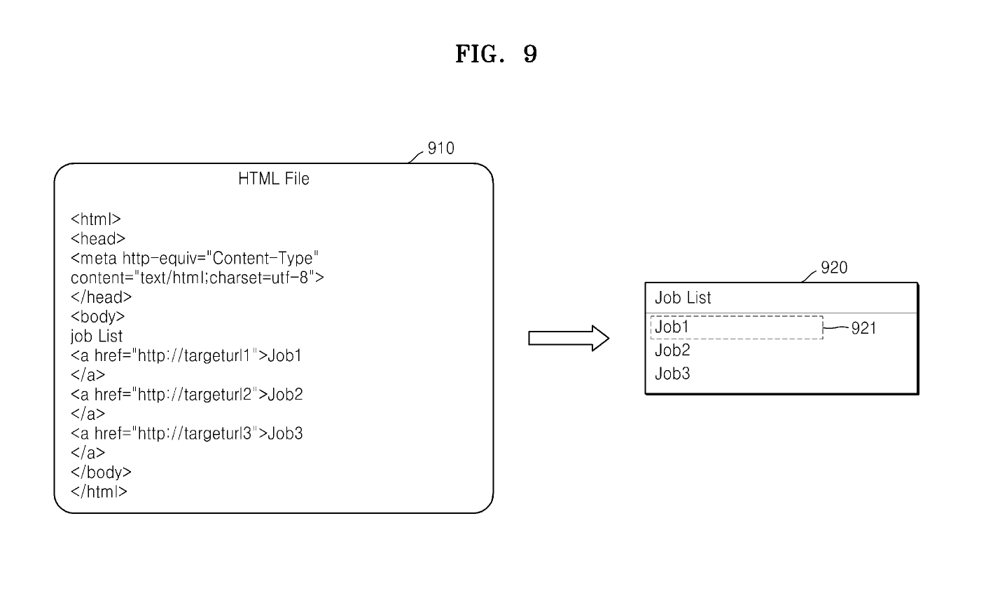

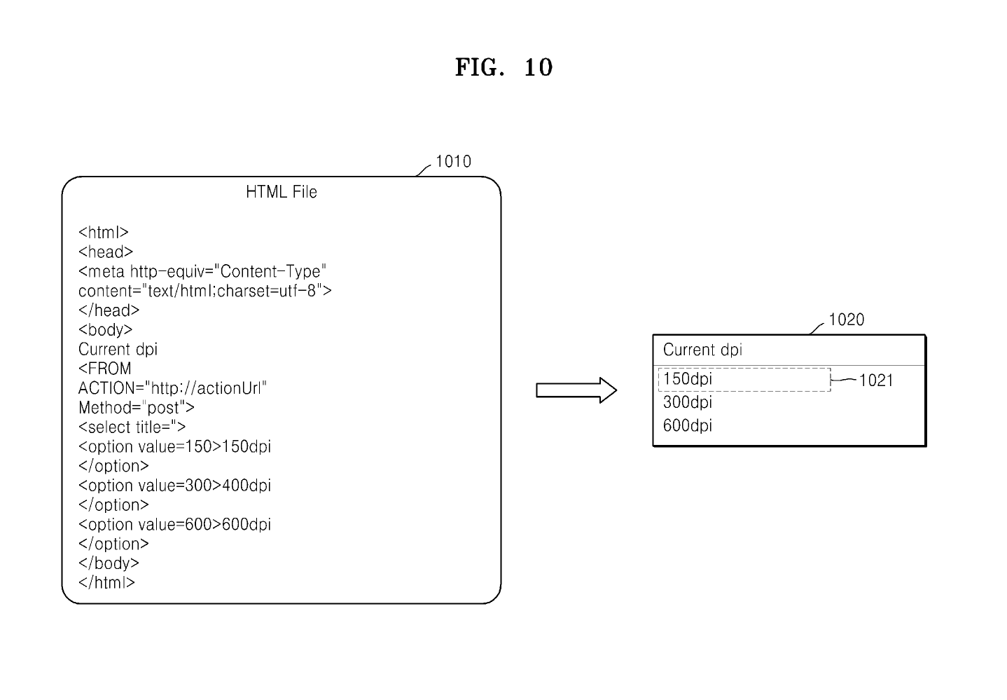

FIG. 9 illustrating an example of a process of text data by interpreting a tag of an HTML file. Referring to FIG. 9, an HTML file 910 includes an a tag corresponding to a link. Therefore, text data is generated to include character strings “Job1”, “Job2”, and “Job3” included in the a tag, and is displayed on an LCD screen 920. In a state where the text data is displayed on the LCD screen 920, if a user selects the “Job1” in a region 921 via an input button of the image forming apparatus 100, a destination “http://targeturl1” defined by the a tag to correspond to the character string “Job1” may be accessed. Similarly, the character string “Job2” or “Job3” is selected, the destination corresponding to the character string and defined by the a tag may be accessed.

If the HTML file 910 includes a tag to set options such as a select tag and an option tag, the text viewer 130 extracts such a tag and may generate text data including character strings included in the tag. In addition, when one of the character strings displayed on the display unit 110, options defined by the extracted tag may be set.

FIG. 10 illustrates a detailed example of a process of displaying text data by interpreting a tag of an HTML file. Referring to FIG. 10, an HTML file 1010 includes a select tag and an option tag to set options corresponding to printing resolution. Therefore, text data is generated so as to include character strings included in the option tag, that is, “150 dpi”, “300 dpi”, and “600 dpi”, and is displayed on an LCD screen 1020. As such, when a user selects the character string “150 dpi” in a region 1021 by using an input button of the image forming apparatus 100 in a state where the text data is displayed on the LCD screen 1020, the resolution option is set as 150 that is defined as an option corresponding to the character string “150 dpi” by the option tag. Similarly, when the character string “300 dpi” or “600 dpi” is selected, option values defined by the option tag to correspond to the selected character string may be set.

The web service server 140 reads the HTML file from the web application server 200, and then, the web service server 140 caches the HTML file and transmits the HTML file to the text viewer 130.

The image forming job execution unit 150 performs an image forming job according to the control of the control unit 120.

In addition, when the user selects one of the character strings displayed on the display unit 110 by using the hard button provided in the image forming apparatus 100 in a state where the text data is displayed on the display unit 110, the control unit 120 controls the image forming job execution unit 150 to perform the image forming job corresponding to the selected character string according to the web application.

In particular, when the display/button driver 121 recognizes which one of the character strings displayed on the display unit 110 is selected and transfers the recognized result to the UI component 122, the selected character string is transferred to the web service server 140 via the text viewer 130. The web service server 140 generates an HTTP packet corresponding to the selected character string with reference to the cached HTML file, and then, transfers the generated HTTP packet to the web application server 200.

For example, if a character string corresponding to a scanning operation is selected from among the character strings displayed on the display unit 110, an HTTP packet representing that the scan operation is selected is generated and transferred to the web application server 200. The web application server 200 analyzes the HTTP packet to recognize that the scan operation is selected, and generates an HTTP packet to direct the scan operation and transfers the HTTP packet to the image forming apparatus 100.

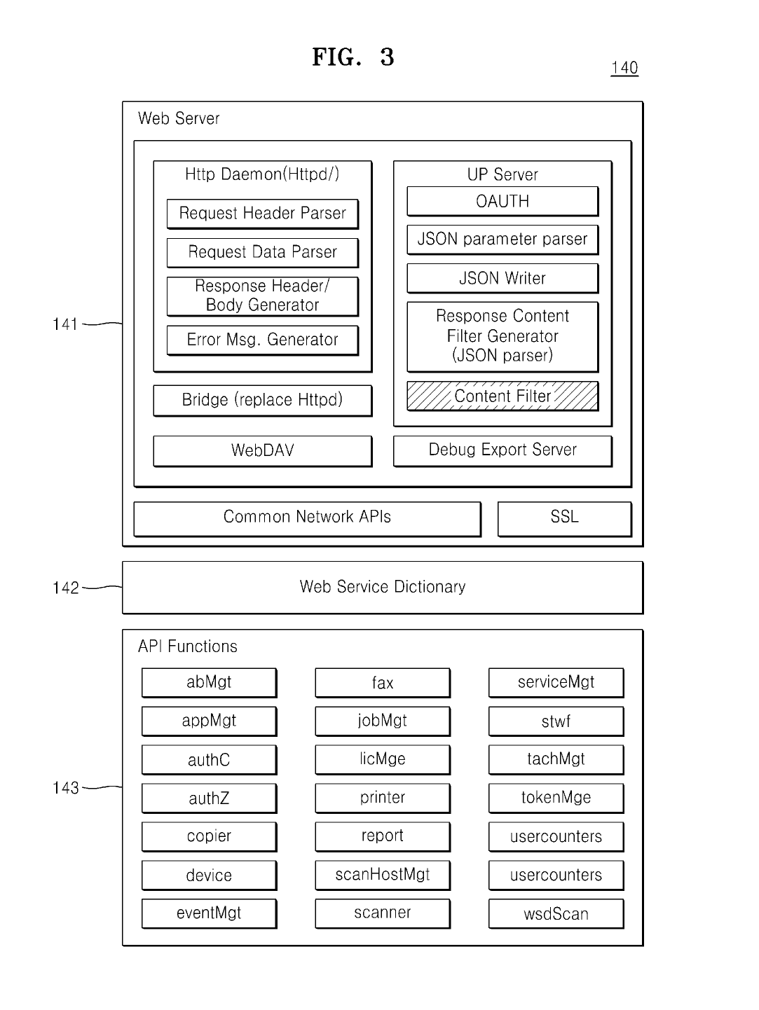

FIG. 3 is a block diagram of the web service server 140 of FIG. 2 in more detail. Referring to FIG. 3, the web service server 140 included in the image forming apparatus 100 includes three components. A web server 141 acts as a service server, a web service dictionary 142 acts as a dictionary to determine whether the service is supported, and an application program interface (API) functions 143 provides functions corresponding to each service.

Since the web service server 140 is the same as the web service server included in an image forming apparatus supporting the browser except for a content filter included in the web server 141, detailed descriptions about the components in the web service server 140 are not provided here.

The content filter included in the web server 141 reads an HTML file from the web application server 200, and caches the HTML file. In the image forming apparatus supporting the browser, the browser reads and caches the HTML file; however, since the image forming apparatus 100 according to FIG. 3 does not support the browser, the content filter acts the above functions instead of the browser.

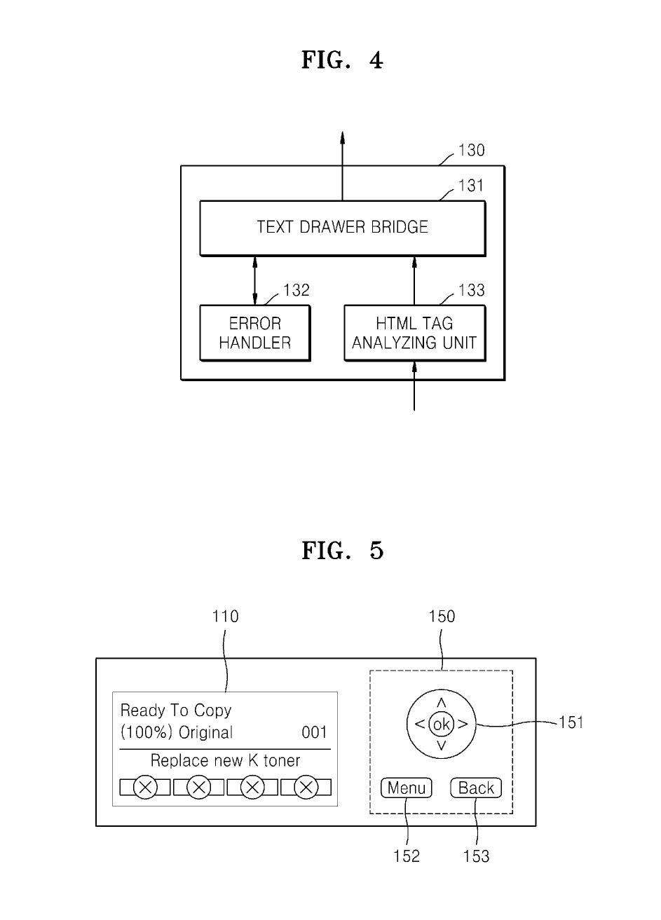

FIG. 4 is a diagram illustrating the text viewer 130 of FIG. 2. Referring to FIG. 4, the text viewer 130 included in the image forming apparatus 100 according to the present embodiment includes a text drawer bridge 131, an error handler 132, and an HTML tag analyzing unit 133.

The HTML tag analyzing unit 133 parses the HTML file read by the web service server 140 to extract a tag, and analyzes the tag to generate text data.

The error handler 132 handles errors corresponding to HTTP standard status codes. If an error occurs, a message representing occurrence of the error is displayed on the display unit 110 via the text drawer bridge 131.

The text drawer bridge 131 receives the text data generated by the HTML tag analyzing unit 133, and displays the text data on the display unit 110 by using the display/button driver 121 included in the control unit 120.

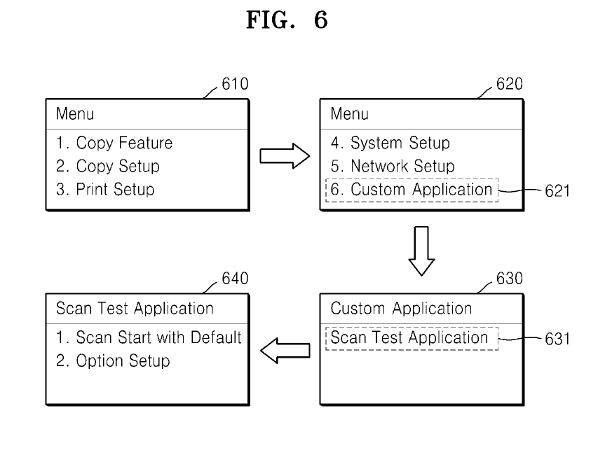

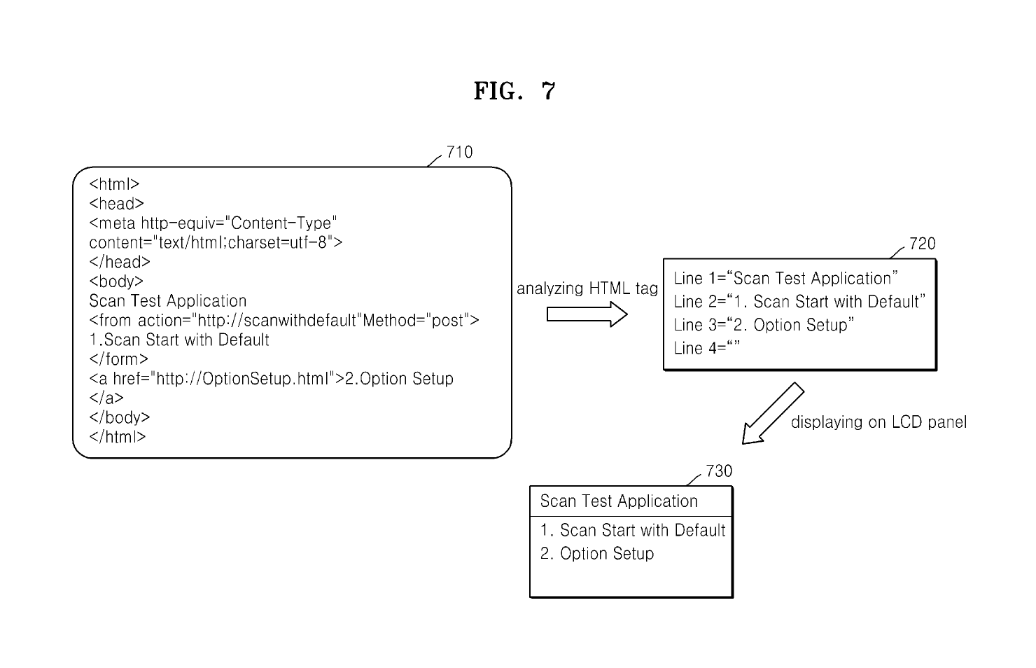

FIG. 5 is a diagram illustrating the display unit 110 and a manipulation panel 150 included in the image forming apparatus 100 according to an exemplary embodiment of the present general inventive concept. The display unit 110 illustrated in FIG. 5 is a four-line LCD panel. The manipulation panel 150 is provided at a side of the display unit 110. The manipulation panel 150 includes hard buttons such as a navigation button 151, a menu button 152, and a back button 153. The user manipulates the navigation button 151 of the manipulation panel 150 to move a cursor displayed on the display unit 110 to a desired menu, and then, pushes an OK button in a center of the navigation button 151 to execute a desired application. Also, the user may select the menu button 152 to terminate the application that is currently executed and move to an out of box (OOB) application portal, and may select the back button 153 to move to a previous menu, that is, to an upper node in an HTML tree structure. Detailed processes of searching to find a menu and executing the application by using the manipulation panel 150 will be described below with reference to FIG. 6.

FIG. 6 is a diagram illustrating processes of inputting a command to execute a web application, according to an exemplary embodiment of the present general inventive concept. Hereinafter, processes of executing the web application by selecting a menu will be described with reference to FIGS. 5 and 6. In FIG. 6, a first screen 610 is a screen displaying a first screen of a main menu. That is, the first screen 610 corresponds to a basic screen of an OOB application portal. When the user pushes a right or down button of the navigation button 151 in order to display other items included in the main menu, a second screen 620 is displayed.

In a state where the second screen 620 is displayed, when the user manipulates the navigation button 151 so that the cursor may be located at a character string in a region 621 and pushes the OK button, an item “6. Custom application” is selected and detailed items corresponding to the selection are displayed. Since the custom application denotes a web application installed by the user, a third screen 630 displays “scan test application” as a detailed item of the “custom application”.

The user manipulates the navigation button 151 in the third screen 630 so that the cursor may be located at a character string in a region 631, and then, pushes the OK button to select the item “scan test application”. When the item “scan test application” is selected, the image forming apparatus 100 recognizes it as a command to execute the corresponding web application and accesses the web application server to read an HTML file, such that a fourth screen 640 is displayed to correspond to the selected “scan test application”.

The image forming apparatus 100 analyzes the HTML file to generate text data, and displays the text data on the display unit 110. Processes of analyzing the HTML file and generating the text data are described above with reference to FIG. 2, and an example of generating and displaying the text data on the four-line LCD panel is illustrated in FIG. 7.

FIG. 7 is a diagram illustrating processes of displaying text data that is generated by analyzing the HTML file, according to an exemplary embodiment of the present general inventive concept. Referring to FIG. 7, text data 720 is generated by analyzing an HTML tag in an HTML file 710, and a text screen 730 is displayed on the four-line LCD panel according to the text data 720. Here, since the HTML file 710 includes three character strings, the text data 720 is generated so that the character strings are displayed in three lines of the four-line LCD panel and remaining one line of the four-line LCD panel does not display anything. The text data 720 may be generated to define text to be displayed in each of the lines.

FIGS. 8 through 10 are diagrams illustrating processes of displaying text data by analyzing a tag of an HTML file according to exemplary embodiments of the present general inventive concept. The processes of FIGS. 8 through 10 have already been described above with reference to FIG. 2, and descriptions thereof are omitted here.

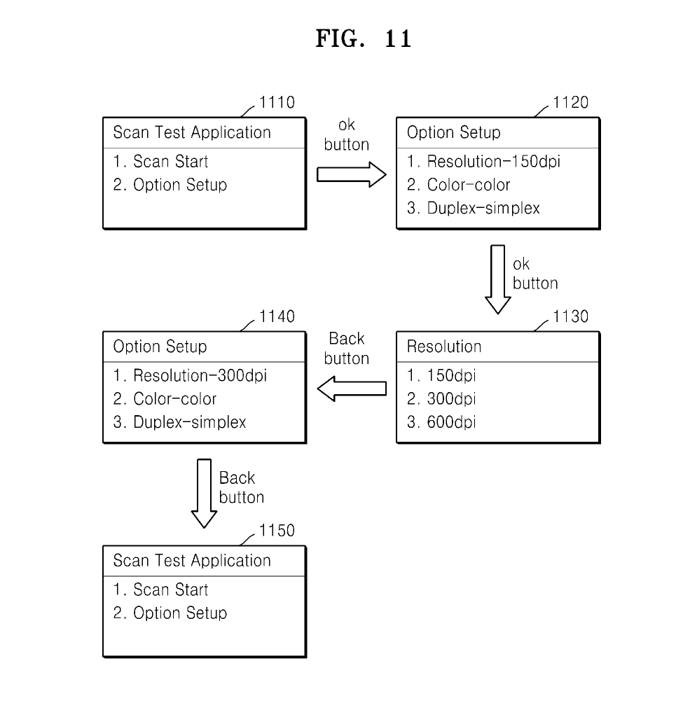

FIG. 11 is a diagram illustrating processes of setting options on a text data screen, according to an exemplary embodiment of the present general inventive concept. A first screen 1110 illustrates a state in which the scan test application is executed and the text data generated by analyzing the HTML file read from the web application server is displayed. When the user selects an item “2. Option setup” via the navigation button and pushes the OK button, the HTML file about the option setting is analyzed and the text data is generated and displayed on a second screen 1120. The second screen 1120 displays detailed items in available options.

The user selects an item “1. Resolution—150 dpi” from among the detailed items to set options and pushes the OK button in the second screen 1120, and then, an HTML file to set the selected option is analyzed and text data is generated and displayed as illustrated in a third screen 1130. The third screen 1130 displays available settings corresponding to the resolution option as the detailed items.

The user selects a desired resolution value, that is, “2. 300 dpi” and pushes the back button in the third screen 1130, and then, the resolution is set as 300 dpi that corresponds to the selected character string and a fourth screen 1140 displays detailed items of the available options. In this state, when the user pushes the back button once more, a fifth screen 1150 displaying a basic menu of the scan test application is illustrated.

As described above, the cursor is moved to select a character string on the display only displaying the text, and thus, the functions of the HTML file may be performed.

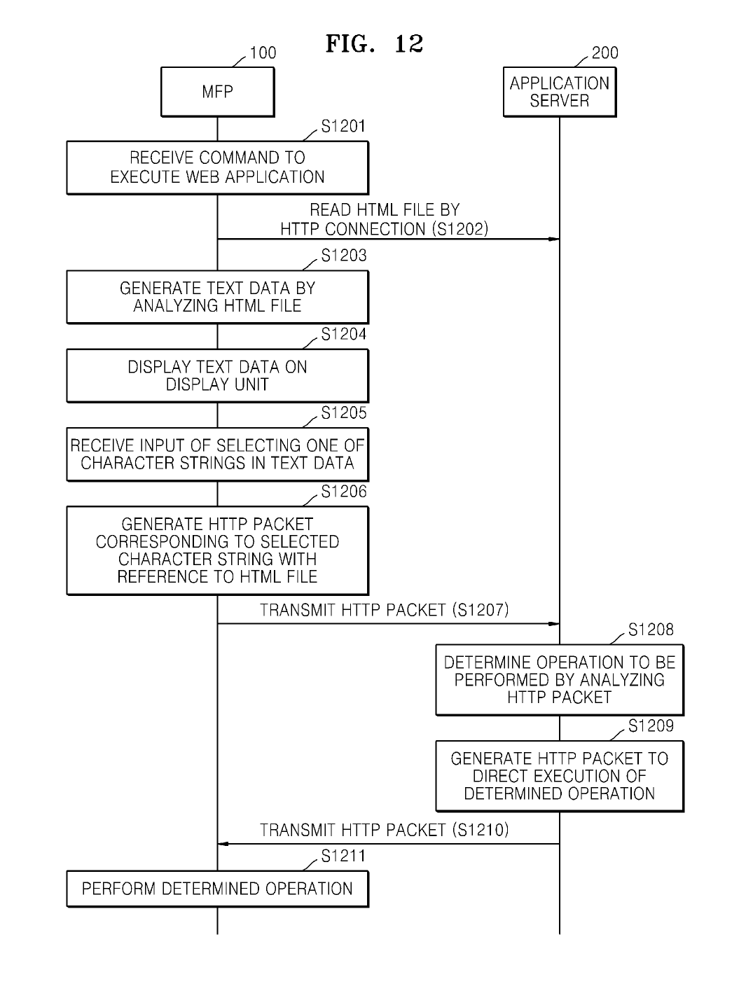

FIG. 12 is a diagram illustrating operations performed by a multi-function printer (MFP) 100 and an application server when a web application is executed, according to an exemplary embodiment of the present general inventive concept. Referring to FIG. 12, the MFP 100 receives a command to execute the web application from the user (S1201), and is connected to an application server 200 to read an HTML file about the web application (S1202).

The MFP 100 analyzes the HTML file to generate text data in operation S1203, and displays the text data on a display unit of the MFP 100 in operation S1204. Here, if the HTML file includes a graphic component, the text data is generated to include the character string only, except for the graphic component. Also, a form tag, an a tag, a select tag, or an option tag may be extracted and analyzed to generate the text data from among the tags included in the HTML file.

When one of the character strings displayed on the display unit is selected (S1205), an HTTP packet corresponding to the selected character string is generated with reference to the HTML file (S1206), and the HTTP packet is transferred to the application server 200 (S1207).

The application server 200 analyzes the HTTP packet transmitted from the MFP to determine an operation to be performed (S1208), and generates an HTTP packet to direct execution of the determined operation (S1209).

In addition, the application server 200 transmits the HTTP packet to the MFP 100 (S1210), the MFP 100 analyzes the HTTP packet to perform an image forming job corresponding to the HTTP packet (S1211).

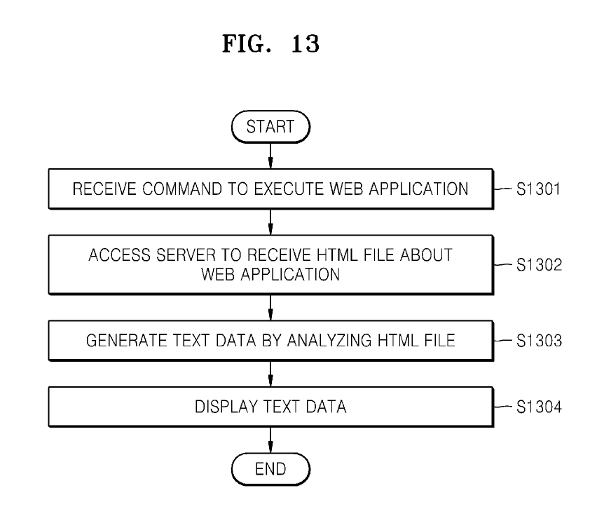

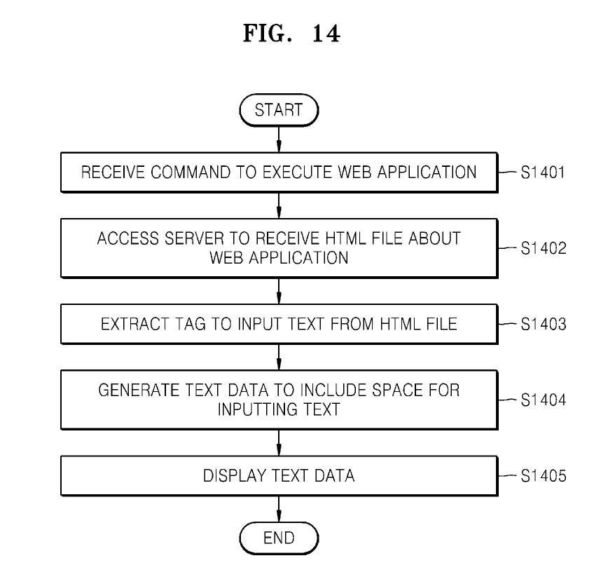

FIG. 13 is a flowchart illustrating a method of executing a web application, according to an exemplary embodiment of the present general inventive concept.

Referring to FIG. 13, when an image forming apparatus receives a command to execute a web application (S1301), the image forming apparatus accesses a server in which the web application is provided to receive an HTML file about the web application (S1302). The HTML file is analyzed to generate text data (S1303), and the text data is displayed (S1304). Here, processes of analyzing the HTML file and generating the text data in operation S1303 are described above.

FIGS. 14 through 16 illustrate methods of generating text data according to a tag extracted from an HTML file according to exemplary embodiments of the present general inventive concept.

Referring to FIG. 14, when an image forming apparatus receives a command to execute a web application (S1401), the image forming apparatus accesses a server in which the web application is provided to receive an HTML file about the web application (S1402). A tag to input text is extracted from the HTML file (S1403). The tag to input text may be, for example, input type=“text” of a form tag. After extracting the tag to input the text, text data is generated so as to include a space to input the text (S1404). That is, an empty space to which the text input by the user is inserted is displayed on the display unit. When generating the text data, the text data is displayed (S1405).

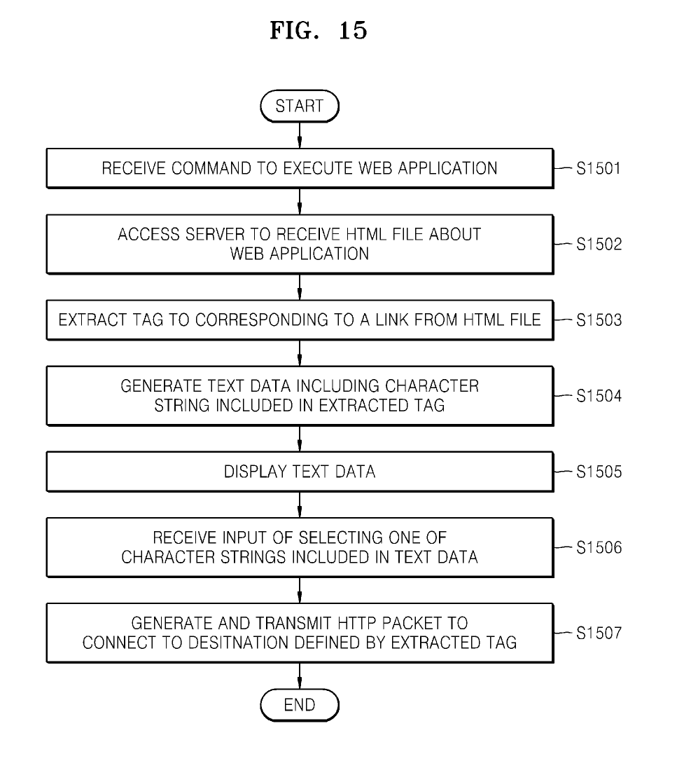

Referring to FIG. 15, when an image forming apparatus receives a command to execute a web application (S1501), the image forming apparatus accesses a server in which the web application is provided to receive an HTML file about the web application (S1502). A tag corresponding to a link is extracted from the HTML file (S1503). For example, an a tag is extracted. When extracting the tag corresponding to a link, text data is generated so as to include a character string included in the extracted tag (S1504). In addition, the text data is displayed (S1505).

In addition, when one of the character strings included in the text data is selected by the user in a state where the text data is displayed (S1506), an HTTP packet to connect to a destination that is defined to correspond to the character string in the extracted tag is generated and transmitted to a server (S1507).

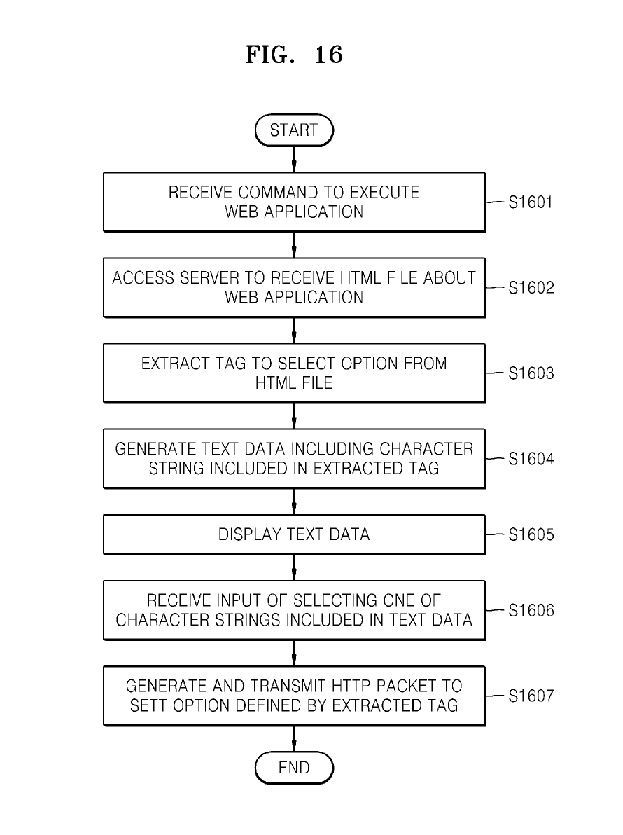

Referring to FIG. 16, when an image forming apparatus receives a command to execute a web application (S1601), the image forming apparatus accesses a server in which the web application is provided to receive an HTML file about the web application (S1602). A tag to select an option is extracted from the HTML file (S1603). For example, a select tag and an option tag are extracted. After extracting the tag to select the option, text data is generated so as to include character strings included in the extracted tag (S1604). In addition, the text data is displayed (S1605).

In addition, when one of the character strings included in the text data is selected by the user in a state where the text data is displayed (S1606), an HTTP packet to set an option that is defined to correspond to the character string selected in the extracted tag is generated and transmitted to the server (S1607).

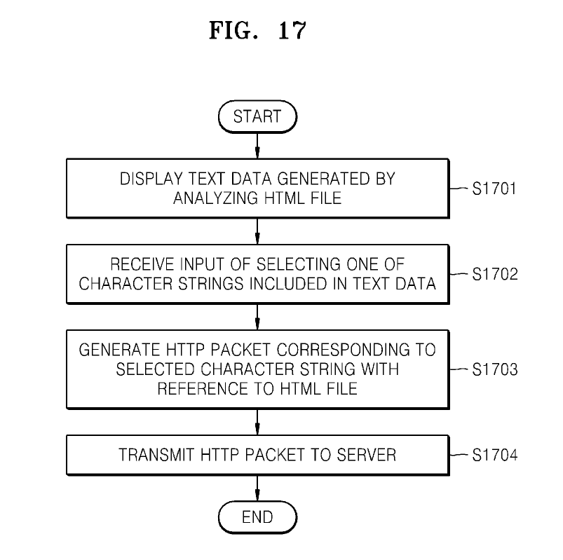

FIG. 17 is a flowchart illustrating a method of executing a web application according to an exemplary embodiment of the present general inventive concept. Referring to FIG. 17, text data generated by analyzing an HTML file read from the server in which the web application is installed is displayed (S1701). One of character strings included in the displayed text data is selected by a user (S1702). An HTTP packet corresponding to the selected character string is generated with reference to the HTML file (S1703), and the HTTP packet is transmitted to the server (S1704).

As described above, the text data is generated by analyzing the HTML file about the web application, and the text data is displayed so that the web application based on the HTML may be executed in the image forming apparatus including a two-line LCD or a four-line LCD that only supports the display of text format, not the browser.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of executing a web application, the method comprising:
receiving an input to execute a web application in an image forming apparatus;
reading a hypertext markup language (HTML) file by connecting to a server supporting the web application;
generating text data by analyzing the HTML file; and
displaying the text data on a display unit provided in the image forming apparatus.

2. The method of claim 1, wherein the generating of the text data comprises generating the text data so as to only include character string included in the HTML file, except corresponding to graphic configurations in the HTML file.

3. The method of claim 1, further comprising:
receiving an input of selecting one of the at least one character string included in the text data displayed on the display unit; and
performing an image forming job corresponding to the selected character string according to the web application.

4. The method of claim 1, wherein the display unit is a liquid crystal display (LCD) panel capable of displaying a plurality of character string lines, and the text data defines a character string to be displayed on each of the plurality of character string lines in the LCD panel.

5. The method of claim 1, wherein the generating of the text data comprises extracting some of tags included in the HTML file, and generating the text data according to the tags that are extracted.

6. The method of claim 5, wherein the generating of the text data comprises extracting at least one of a form tag, an a tag, a select tag, and an option tag included in the HTML file, and analyzing the tag that is extracted to generate the text data.

7. The method of claim 5, wherein if a tag to input text is extracted from the HTML file, the text data includes a space to receive text input.

8. The method of claim 5, wherein if a tag corresponding to a link is extracted from the HTML file, the text data includes at least one character string included in the tag that is extracted, and when one of the at least one character string is selected, a destination defined by the tag that is extracted is connected.

9. The method of claim 5, wherein if a tag to select an option is extracted from the HTML file, the text data includes at least one character string included in the tag that is extracted, and when one of the at least one character string is selected, an option defined by the tag that is extracted is set.

10. A computer-readable recording medium having embodied thereon a program to execute a method of executing a web application, wherein the method comprises
receiving an input to execute a web application in an image forming apparatus;
reading a hypertext markup language (HTML) file by connecting to a server supporting the web application;
generating text data by analyzing the HTML file; and
displaying the text data on a display unit provided in the image forming apparatus.

11. An image forming apparatus to execute a web application, the image forming apparatus comprising:
a display unit to display character strings;
a web service server to read a hypertext markup language (HTML) file from a web application installed in a server;
a text viewer to generate text data by analyzing the HTML file;
a control unit to display the text data on the display unit, and to control execution of the web application; and
an image forming job execution unit to perform an image forming job according to the execution of the web application.

12. The image forming apparatus of claim 11, wherein the text viewer generates the text data so that the text data may only include character string included in the HTML file except corresponding to graphic configurations included in the HTML file.

13. The image forming apparatus of claim 11, wherein when the control unit receives an input of selecting one of at least one character string included in the text data displayed on the display unit, the control unit controls the image forming job execution unit to perform an image forming job corresponding to the character string that is selected according to the web application.

14. The image forming apparatus of claim 11, wherein the display unit is a liquid crystal display (LCD) panel capable of displaying a plurality of character string lines, and the text viewer generates the text data so as to define a character string to be displayed in each of the plurality of character string lines of the LCD panel.

15. The image forming apparatus of claim 11, wherein the text viewer extracts some of tags included in the HTML file, and generates the text data according to the tags that are extracted.

16. The image forming apparatus of claim 15, wherein the text viewer extracts at least one of a form tag, an a tag, a select tag, and an option tag included in the HTML file, and analyzes the tag that is extracted to generate the text data.

17. The image forming apparatus of claim 15, wherein if a tag to input text is extracted from the HTML file, the text viewer generates the text data so as to include a space for receiving text input.

18. The image forming apparatus of claim 15, wherein if a tag corresponding to a link is extracted from the HTML file, the text viewer generates the text data so as to include at least one character string included in the tag that is extracted, and when one of the at least one character string is selected, the control unit connects to a destination defined by the tag that is extracted.

19. The image forming apparatus of claim 15, wherein if a tag to select an option is extracted from the HTML file, the text viewer generates the text data so as to include at least one character string included in the tag that is extracted, and when one of the at least one character string is selected, the control unit sets an option defined by the tag that is extracted.

20. An image forming apparatus to execute a web application, the image forming apparatus comprising:
a display unit;
a text viewer to convert an image in a web application corresponding to a function into a selectable character string displayed on the display unit; and
an image forming job execution unit to perform the function upon selection of the character string.

21. The image forming apparatus of claim 20, wherein the display unit is a text only display unit.

22. The image forming apparatus of claim 20, wherein the text viewer performs the conversion by extracting tags included in an HTML file to generate text data in a format according to the extracted tags.

23. The image forming apparatus of claim 22, wherein the extracted tags include at least one of a form tag, an a tag, a select tag, and an option tag.
